(19) United States
(12) Patent Application Publication
(10) Pub. No.: US 2019/0168426 A1
(43) Pub. Date: Jun. 6, 2019

(54) FIBRE REINFORCEMENT OF REACTIVE FOAM MATERIAL OBTAINED BY A DOUBLE STRIP FOAM METHOD OR A BLOCK FOAM METHOD

(71) Applicant: BASF SE, Ludwigshafen am Rhein (DE)

(72) Inventors: Holger RUCKDAESCHEL, Ludwigshafen am Rhein (DE); Alexandre TERRENOIRE, Lampertheim (DE); Rene ARBTER, Ludwigshafen am Rhein (DE); Bangaru Dharmapuri Sriramul SAMPATH, Ludwigshafen am Rhein (DE); Peter GUTMANN, Ludwigshafen am Rhein (DE); Ragnar STOLL, Lemfoerde (DE); Robert STEIN, Ludwigshafen am Rhein (DE); Christophe Leon Marie HEBETTE, Nanjing (CN)

(21) Appl. No.: 16/303,423

(22) PCT Filed: May 17, 2017
(86) PCT No.: PCT/EP2017/061868

§ 371 Date: Nov. 20, 2018

(30) Foreign Application Priority Data
May 25, 2016 (EP) 16171418.3

(51) Int. Cl. B29C 44/12; B29C 44/30; B29C 44/56; B29C 70/14

(52) U.S. Cl. CPC B29C 44/128; B29C 44/30; B32B 5/18; B29C 70/14; B29C 44/5681

(57) ABSTRACT

The present invention relates to a molding made of reactive foam, wherein at least one fiber (F) is arranged partially inside the molding, i.e. is surrounded by the reactive foam. The two ends of the respective fiber (F) not surrounded by the reactive foam thus each project from one side of the corresponding molding. The reactive foam is produced by a double belt foaming process or a block foaming process. The present invention further provides a panel comprising at least one such molding and at least one further layer (S1). The present invention further provides processes for producing the moldings according to the invention from reactive foam/the panels according to the invention and also provides for the use thereof as a rotor blade in wind turbines for example.

The present invention relates to a molding made of reactive foam, wherein at least one fiber (F) is arranged partially inside the molding, i.e. is surrounded by the reactive foam. The two ends of the respective fiber (F) not surrounded by the reactive foam thus each project from one side of the corresponding molding. The reactive foam is produced by a double belt foaming process or a block foaming process. The present invention further provides a panel comprising at least one such molding and at least one further layer (S1). The present invention further provides processes for producing the moldings according to the invention from reactive foam/the panels according to the invention and also provides for the use thereof as a rotor blade in wind turbines for example.

WO 2006/125561 relates to a process for producing a reinforced cellular material, wherein at least one hole extending from a first surface to a second surface of the cellular material is produced in the cellular material in a first process step. On the other side of the second surface of the cellular material, at least one fiber bundle is provided, said fiber bundle being drawn with a needle through the hole to the first side of the cellular material. However, before the needle takes hold of the fiber bundle, the needle is first pulled through the particular hole coming from the first side of the cellular material. In addition, the fiber bundle, on conclusion of the process according to WO 2006/125561, is arranged partially inside the cellular material, since it fills the corresponding hole, and the corresponding fiber bundle partially projects from the first and second surfaces of the cellular material on the respective sides.

By the process described in WO 2006/125561, it is possible to produce sandwich-like components comprising a core of said cellular material and at least one fiber bundle. Resin layers and fiber-reinforced resin layers may be applied to the surfaces of this core, in order to produce the actual sandwich-like component. Cellular materials used to form the core of the sandwich-like component may, for example, be polyvinyl chlorides or polyurethanes. Examples of useful fiber bundles include carbon fibers, nylon fibers, glass fibers or polyester fibers.

However, WO 2006/125561 does not disclose that reactive foams produced by a double belt foaming process or a block foaming process can be used as cellular material for producing a core in a sandwich-like component. The sandwich-like components according to WO 2006/125561 are suitable for use in aircraft construction.

WO 2011/012587 relates to a further process for producing a core with integrated bridging fibers for panels made from composite materials. The core is produced by pulling the bridging fibers provided on a surface of what is called a “cake” made from lightweight material partially or completely through said cake with the aid of a needle. The “cake” may be formed from polyurethane foams, polyester foams, polyethylene terephthalate foams, polyvinyl chloride foams or a phenolic foam, especially from a polyurethane foam. The fibers used may in principle be any kind of single or multiple threads and other yarns.

The cores thus produced may in turn be part of a panel made from composite materials, wherein the core is surrounded on one or two sides by a resin matrix and combinations of resin matrices with fibers in a sandwich-like configuration. However, WO 2011/012587 does not disclose that reactive foams produced by a double belt foaming process or a block foaming process can be used for producing the corresponding core material.

WO 2012/138445 relates to a process for producing a composite core panel using a multitude of longitudinal strips of a cellular material having a low density. A double-ply fiber mat is introduced between the individual strips, and this brings about adhesive bonding of the individual strips, with use of resin, to form the composite core panels. The cellular material having a low density that forms the longitudinal strips, according to WO 2012/138445, is selected from balsa wood, elastic foams and fiber-reinforced composite foams. The fiber mats introduced in a double-ply arrangement between the individual strips may be a porous glass fiber mat for example. The resin used as adhesive may, for example, be a polyester, an epoxy resin or a phenolic resin, or a heat-activated thermoplastic, for example polypropylene or PET. However, WO 2012/138445 does not disclose that it is also possible to use as the cellular material for the elongated strips a reactive foam produced by a double belt foaming process or a block foaming process, Nor is it disclosed therein that individual fibers or fiber bundles can be introduced into the cellular material for reinforcement. According to WO 2012/138445, exclusively fiber mats that additionally constitute a bonding element in the context of an adhesive bonding of the individual strips by means of resin to obtain the core material are used for this purpose.

GB-A 2 455 044 discloses a process for producing a multilayer composite article, wherein, in a first process step, a multiplicity of pellets made of thermoplastic material and a blowing agent are provided. The thermoplastic material is a mixture of polystyrene (PS) and polyphenylene oxide (PPO) comprising at least 20% to 70% by weight of PPO. In a second process step the pellets are expanded, and in a third step they are welded in a mold to form a closed-cell foam of the thermoplastic material to give a molding, the closed-cell foam assuming the shape of the mold. In the next process step, a layer of fiber-reinforced material is applied to the surface of the closed-cell foam, the bonding of the respective surfaces being conducted using an epoxy resin. However, GB-A 2 455 044 does not disclose that a fiber material can be introduced into the core of the multilayer composite article.

An analogous process and an analogous multilayer composite article (to those in GB-A 2 455 044) is also disclosed in WO 2009/047483. These multilayer composite articles are suitable, for example, for use of rotor blades (in wind turbines) or as ships' hulls.

U.S. Pat. No. 7,201,625 discloses a process for producing foam products and the foam products as such, which can be used, for example, in the sports sector as a surfboard. The core of the foam product is formed by a particle foam, for example based on a polystyrene foam. This particle foam is produced in a special mold, with an outer plastic skin surrounding the particle foam. The outer plastic skin may, for example, be a polyethylene film. However, U.S. Pat. No. 7,201,625 also does not disclose that fibers for reinforcement of the material may be present in the particle foam.

U.S. Pat. No. 6,767,623 discloses sandwich panels having a core layer of polypropylene particle foam based on particles having a particle size in the range from 2 to 8 mm and a bulk density in the range from 10 to 100 g/l. In addition, the sandwich panels comprise two outer layers of fiber-reinforced polypropylene, with the individual outer layers being arranged around the core so as to form a sandwich. Still further layers may optionally be present in the sandwich panels for decorative purposes. The outer layers may comprise glass fibers or other polymer fibers.

EP-A 2 420 531 discloses extruded foams based on a polymer such as polystyrene comprising at least one mineral filler having a particle size of ≤10 μm and at least one nucleating agent. These extruded foams feature improved stiffness. Additionally described is a corresponding extrusion process for producing such extruded foams based on polystyrene. The extruded foams may be closed-cell foams. However, EP-A 2 480 531 does not state that the extruded foams comprise fibers.

WO 2005/056653 relates to particle foam moldings made of expandable, filler-comprising polymer granulates. The particle foam moldings are obtainable by welding prefoamed foam particles made of expandable, filler-comprising thermoplastic polymer granulates, the particle foam having a density in the range from 8 to 300 g/l. The thermoplastic polymer granulates are in particular a styrene polymer. The fillers used may be pulverulent inorganic substances, metal, chalk, aluminum hydroxide, calcium carbonate or alumina, or inorganic substances in the form of beads or fibers, such as glass beads, glass fibers or carbon fibers.

U.S. Pat. No. 3,030,256 describes laminated panels and a process for the production thereof. The panels comprise a core material into which fiber bundles have been introduced and surface materials. The core materials are foamed plastic or expanded plastic. The fibers are arranged inside the foam with one fiber region while a first fiber region projects out of the first side of the molding and a second fiber region projects out of the second side of the molding.

U.S. Pat. No. 6,187,411 relates to reinforced sandwich panels which comprise a foam core material that comprises a fiber layer on both sides and fibers that are stitched through the outer fiber layers and the foam. Described foam core materials include polyurethanes, phenols and isocyanates. A reactive foam produced by a double belt foaming process or a block foaming process is not disclosed.

US 2010/0196652 relates to quasi-isotropic sandwich structures comprising a core material surrounded by fiber mats, wherein glass fiber rovings are stitched into the fiber mats and the core material. Foams described include various foams such as for example polyurethane, polyisocyanurate, phenols, polystyrene (PEI), polyethylene, polypropylene and the like.

The disadvantage of the composite materials described in U.S. Pat. Nos. 3,030,256, 6,187,411 and US 2010/0196652 is that these often have poor mechanical properties and/or a high resin absorption.

There is a multiplicity of different production processes, materials and consequent properties for the production of reactive foams. An overview is provided for example in ‘Polyurethane and related foams’, K. Ashida, 2006, CRC, in Polyurethane Handbook, G. Oertel, 1994, 2nd edition, Hanser and in Szycher's Handbook of Polyurethanes, M. Szycher, 2012, 2nd edition, CRC.

The present invention accordingly has for its object to provide novel fiber-reinforced moldings/panels.

This object is achieved in accordance with the invention by a molding made of reactive foam, where at least one fiber (F) is with a fiber region (FB2) arranged inside the molding and surrounded by the reactive foam while a fiber region (FB1) of the fiber (F) projects from a first side of the molding and a fiber region (FB3) of the fiber (F) projects from a second side of the molding, wherein the reactive foam has been produced by a double belt foaming process or a block foaming process, wherein the reactive foam comprises cells, wherein at least 50% of the cells are anisotropic.

The present invention further provides a molding made of reactive foam, where at least one fiber (F) is with a fiber region (FB2) arranged inside the molding and surrounded by the reactive foam while a fiber region (FB1) of the fiber (F) projects from a first side of the molding and a fiber region (FB3) of the fiber (F) projects from a second side of the molding, wherein the reactive foam has been produced by a double belt foaming process or a block foaming process.

In other words the reactive foam is obtainable by a double belt foaming process or a block foaming process.

The moldings according to the invention advantageously feature a low resin absorption coupled with good interfacial bonding, wherein the low resin absorption is attributable in particular to the reactive foam produced by a double belt foaming process or a block foaming process. This effect is important especially when the moldings according to the invention are subjected to further processing to afford the panels according to the invention.

Since in the molding the reactive foam comprises cells and these are anisotropic to an extent of at least 50%, preferably to an extent of at least 80% and more preferably to an extent of at least 90% the mechanical properties of the reactive foam and thus also those of the molding are also anisotropic which is particularly advantageous for application of the molding according to the invention in particular for rotor blades in wind turbines, in the transport sector, in the construction sector, in automobile construction, in shipbuilding, in rail vehicle construction, in container construction, in sanitary installations and/or in aerospace.

The moldings according to the invention have a particularly high compressive strength in at least one direction on account of their anisotropy. They additionally feature a high closed-cell content and good vacuum stability.

Since in a preferred embodiment the at least one fiber (F) is introduced into the reactive foam at an angle ε≤60° relative to the largest dimension of the anisotropic cells introduction of the at least one fiber (F) results in the destruction of a smaller number of cells than in the foams described in the prior art which likewise has a positive effect on the resin absorption of the molding upon processing to afford a panel.

In addition, on account of the anisotropy of the cells the sewing resistance in the process for producing moldings is lower than for foams described in the prior art. This enables a faster sewing process and in addition the service life of the needle is prolonged. This makes the process of the invention particularly economic.

A further improvement in bonding with simultaneously reduced resin absorption is enabled in accordance with the invention by the fiber reinforcement of the reactive foams in the inventive moldings/the panels resulting therefrom. According to the invention, the fibers (individually or preferably in the form of fiber bundles) may advantageously be introduced into the reactive foam initially in a dry state and/or by mechanical processes. The fibers/fiber bundles are laid down on the respective reactive foam surfaces not flush, but with an overhang, and thus enable an improved bonding/a direct joining with the corresponding outer plies in the panel according to the invention. This is the case in particular when as an outer ply according to the invention at least one further layer (S1) is applied to the moldings according to the invention to form a panel. It is preferable when two layers (S1) which may be identical or different are applied. It is particularly preferable when two identical layers (S1), in particular two identical fiber-reinforced resin layers, are applied to opposite sides of the molding according to the invention to form a panel according to the invention. Such panels are also referred to as “sandwich materials” and the molding according to the invention may also be referred to as “core material”.

The panels according to the invention thus feature a low resin absorption in conjunction with a good peel strength and a good shear stiffness and a high shear modulus. Moreover, high strength and stiffness properties can be specifically adjusted through the choice of fiber types and the proportion and arrangement thereof. The effect of low resin absorption is important because a common aim in the use of such panels (sandwich materials) is that the structural properties are to be increased while attaining the lowest possible weight. When using for example fiber-reinforced outer plies not only the actual outer plies and the molding (sandwich core) but also the resin absorption of the molding (core material) contribute to the total weight. However, the moldings according to the invention/the panels according to the invention can reduce resin absorption, thus allowing weight and cost savings.

Since the reactive foam of the molding comprises cells that are anisotropic to an extent of at least 50%, preferably to an extent of at least 80%, more preferably to an extent of at least 90%, the resin absorption of the moldings according to the invention and the mechanical properties thereof may be specifically controlled through the alignment of the cells relative to the thickness direction (d) of the molding.

For example the cells may be aligned at an angle γ von 0° relative to the thickness direction (d). This results in a slightly increased resin absorption in the panel according to the invention. However, this is coupled with improved mechanical properties in the thickness direction (d). By contrast, when the cells are aligned at an angle γ of 90° relative to the thickness direction (d) a lower resin absorption is achieved but the mechanical properties remain good.

In addition, further layers (S2) may be applied to the reactive foam during or after manufacture. Such layers improve the overall integrity of the reactive foam/of the molding according to the invention.

Further improvements/advantages can be achieved when the fibers (F) are introduced into the reactive foam at an angle α in the range from 0° to 60° in relation to the thickness direction (d) of the reactive foam, particularly preferably of 0° to 45°. Introduction of the fibers (F) at an angle α of 0° to <90° is generally performable on an industrial scale in automated fashion.

Additional improvements/advantages can be achieved when the fibers (F) are introduced into the reactive foam not only parallel to one another but further fibers (F) are also introduced at an angle β to one another which is preferably in the range from >0 to 180°. This additionally achieves a specific improvement in the mechanical properties of the molding of the invention in different directions.

It is likewise advantageous when in the panels according to the invention the resin (outer) layer is applied by liquid injection methods or liquid infusion methods in which the fibers can be impregnated with resin during processing and the mechanical properties improved. This can additionally result in cost savings.

The present invention is further specified hereinbelow,

According to the invention the molding comprises a reactive foam and at least one fiber (F).

The fiber (F) present in the molding is a single fiber or a fiber bundle, preferably a fiber bundle. Suitable fibers (F) include all materials known to those skilled in the art that can form fibers. For example the fiber (F) is an organic, inorganic, metallic or ceramic fiber or a combination thereof, preferably a polymeric fiber, basalt fiber, glass fiber, carbon fiber or natural fiber, especially preferably a polyaramid fiber, glass fiber, basalt fiber or carbon fiber; a polymeric fiber is preferably a fiber of polyester, polyamide, polyaramid, polyethylene, polyurethane, polyvinyl chloride, polyimide and/or polyamide imide; a natural fiber is preferably a fiber of sisal, hemp, flax, bamboo, coconut and/or jute.

It is preferable to employ fiber bundles. The fiber bundles are composed of a plurality of single fibers (filaments). The number of individual fibers per bundle is at least 10, preferably 100 to 100 000, particularly preferably 300 to 10 000, in the case of glass fibers and 1000 to 50 000 in the case of carbon fibers and especially preferably 500 to 5000 in the case of glass fibers and 2000 to 20 000 in the case of carbon fibers.

According to the invention the at least one fiber (F) is with a fiber region (FB2) arranged inside the molding and surrounded by the reactive foam while a fiber region (FB1) of the fiber (F) projects from a first side of the molding and a fiber region (FB3) of the fiber (F) projects from a second side of the molding.

The fiber region (FB1), the fiber region (FB2) and the fiber region (FB3) may each account for any desired proportion of the total length of the fiber (F). In one embodiment the fiber region (FB1) and the fiber region (FB3) each independently of one another account for 1% to 45%, preferably 2% to 40% and particularly preferably 5% to 30% and the fiber region (FB2) accounts for 10% to 98%, preferably 20% to 96%, particularly preferably 40% to 90%, of the total length of the fiber (F).

It is also preferable when the first side of the molding from which the fiber region (FB1) of the fiber (F) projects is opposite the second side of the molding from which the fiber region (FB3) of the fiber (F) projects.

The fiber (F) has preferably been introduced into the molding at an angle α relative to the thickness direction (d) of the molding/to the orthogonal (of the surface) of the first side of the molding. The angle α may assume any desired values from 0° to 90°. For example the fiber (F) has been introduced into the reactive foam at an angle α of 0° to 60°, preferably of 0° to 50°, more preferably of 0° to 15° or of 10° to 70°, preferably of 30° to 60°, particularly preferably of 30° to 50°, yet more preferably of 30° to 45°, in particular of 45°, relative to the thickness direction (d) of the molding.

In a further embodiment at least two fibers (F) are introduced at two different angles α, α₁ and α₂, wherein the angle α₁ is preferably in the range from 0° to 15° and the second angle α₂ is preferably in the range from 30° to 50°; especially preferably α₁ is in the range from 0° to 5° and α₂ is in the range from 40° to 50°.

It is preferable when a molding according to the invention comprises a multiplicity of fibers (F), preferably as fiber bundles, and/or comprises more than 10 fibers (F) or fiber bundles per m², preferably more than 1000 per m², particularly preferably 4000 to 40 000 per m². It is preferable when all fibers (F) in the molding according to the invention have the same angle α or at least approximately the same angle (deviation of not more than +/−5°, preferably +/−2°, particularly preferably +/−1°.

All fibers (F) may be arranged parallel to one another in the molding. It is likewise possible and preferable according to the invention that two or more fibers (F) are arranged in the molding at an angle β to one another. In the context of the present invention the angle β is to be understood as meaning the angle between the orthogonal projection of a first fiber (F1) onto the surface of the first side of the molding and the orthogonal projection of a second fiber (F2) onto the surface of the molding, wherein both fibers have been introduced into the molding.

The angle β is preferably in the range of β=360°/n, wherein n is an integer. It is preferable when n is in the range from 2 to 6, particularly preferably in the range from 2 to 4. The angle β is 90°, 120° or 180° for example. In a further embodiment the angle β is in the range from 80° to 100°, in the range from 110° to 130° or in the range from 170° to 190°. In a further embodiment more than two fibers (F) have been introduced at an angle β to one another, for example three or four fibers (F). These three or four fibers (F) may each have two different angles β, β₁ and β₂ to the two adjacent fibers. It is preferable when all of the fibers (F) have the same angles β=β₁=β₂ to the two adjacent fibers (F). For example when the angle β is 90° then the angle β₁ between the first fiber (F1) and the second fiber (F2) is 90°, the angle β₂ between the second fiber (F2) and the third fiber (F3) is 90°, the angle β₃ between the third fiber and the fourth fiber (F4) is 90° and the angle β₄ between the fourth fiber (F4) and the first fiber (F1) is likewise 90°. The angles β between the first fiber (F1) (reference) and the second (F2), third (F3) and fourth fiber (F4) are then 90°, 180° and 270° in a clockwise direction. Analogous considerations apply to the other possible angles.

The first fiber (F1) then has a first direction and the second fiber (F2) arranged at an angle β to the first fiber (F1) has a second direction. It is preferable when there is a similar number of fibers in the first direction and in the second direction. “Similar” in the present context is to be understood as meaning that the difference between the number of fibers in each direction relative to the other direction is <30%, particularly preferably <10% and especially preferably <2%.

The fibers or fiber bundles may be introduced in irregular or regular patterns. Preference is given to the introduction of fibers or fiber bundles in regular patterns. “Regular patterns” in the context of the present invention is to be understood as meaning that all fibers are aligned parallel to one another and that at least one fiber or fiber bundle has the same distance (a) from all directly adjacent fibers or fiber bundles. It is especially preferable when all fibers or fiber bundles have the same distance from all directly adjacent fibers or fiber bundles,

In a further preferred embodiment the fibers or fiber bundles are introduced such that based on an orthogonal system of coordinates where the thickness direction (d) corresponds to the z-direction they each have the same distance (aₓ) from one another along the x-direction and the same distance (a_{y}) along the y-direction. It is especially preferable when they have the same distance (a) in the x-direction and in the y-direction, wherein a=aₓ=a_{y}.

In the context of the present invention the thickness direction (d) relates to the thickness of the molding according to the invention and to the thickness of the reactive foam present therein which already has the dimensions with which it is employed in the molding, i.e. to the reactive foam which optionally has been converted for use in the molding according to the invention after production.

When two or more fibers (F) are at an angle β to one another the first fibers (F1) that are parallel to one another preferably have a regular pattern with a first distance (a₁) and the second fibers (F2) that are parallel to one another and are at an angle β to the first fibers (F1) preferably have a regular pattern with a second distance (a₂). In a preferred embodiment the first fibers (F1) and the second fibers (F2) each have a regular pattern with a distance (a). In that case, a=a₁=a₂.

When fibers or fiber bundles are introduced into the extruded foam at an angle β to one another it is preferable that the fibers or fiber bundles follow a regular pattern in each direction.

In a preferred embodiment of the molding according to the present invention the surface of at least one side of the molding has at least one depression, the depression preferably being a slot or a hole.

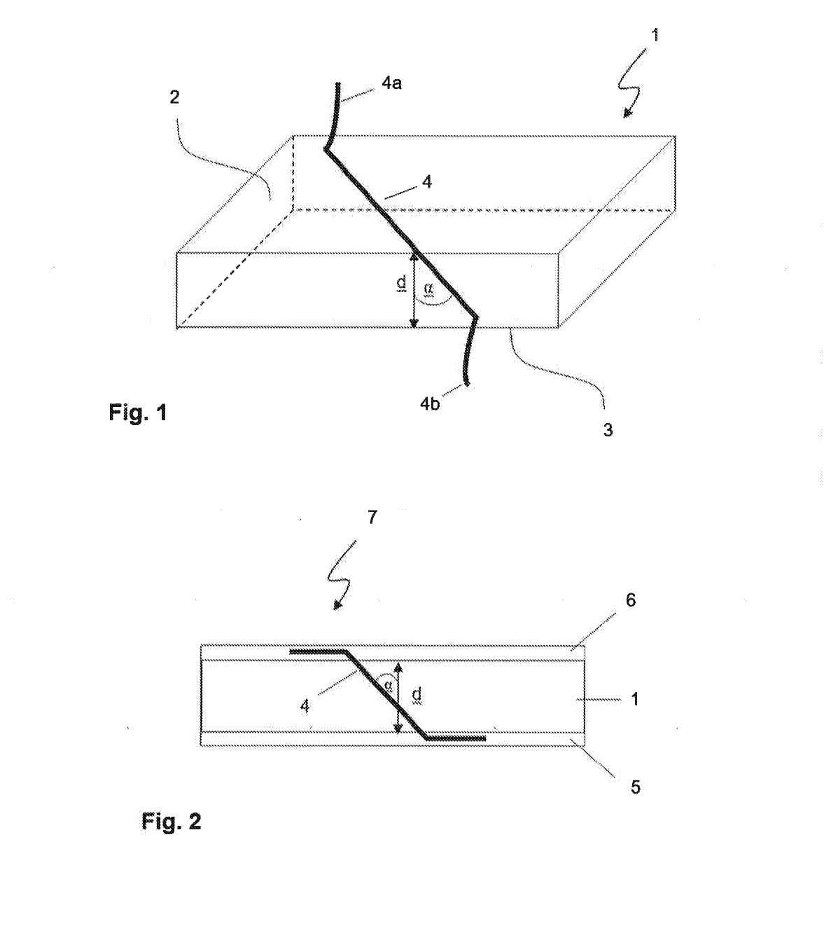

FIG. 1 shows a schematic diagram of a preferred embodiment of the inventive molding made of reactive foam (1) in a perspective view. (2) represents (the surface of) a first side of the molding while (3) represents a second side of the corresponding molding. As further apparent from FIG. 1, the first side (2) of the molding is opposite the second side (3) of this molding. The fiber (F) is represented by (4). One end of this fiber (4a) and thus the fiber region (FB1) projects from the first side (2) of the molding while the other end (4b) of the fiber which constitutes the fiber region (FB3) projects from the second side (3) of the molding. The middle fiber region (FB2) is arranged inside the molding and is thus surrounded by the reactive foam.

In FIG. 1 the fiber (4) which is for example a single fiber or a fiber bundle, preferably a fiber bundle, is arranged at an angle α relative to the thickness direction (d) of the molding/to the orthogonal (of the surface) of the first side (2) of the molding in the molding. The angle α may assume any desired values from 0° to 90° and is normally 0° to 60°, preferably 0° to 50°, particularly preferably 0° to 15° or 10° to 70°, preferably 30° to 60°, more preferably 30° to 50°, very particularly 30° to 45°, in particular 45°. For clarity, FIG. 1 shows just a single fiber (F).

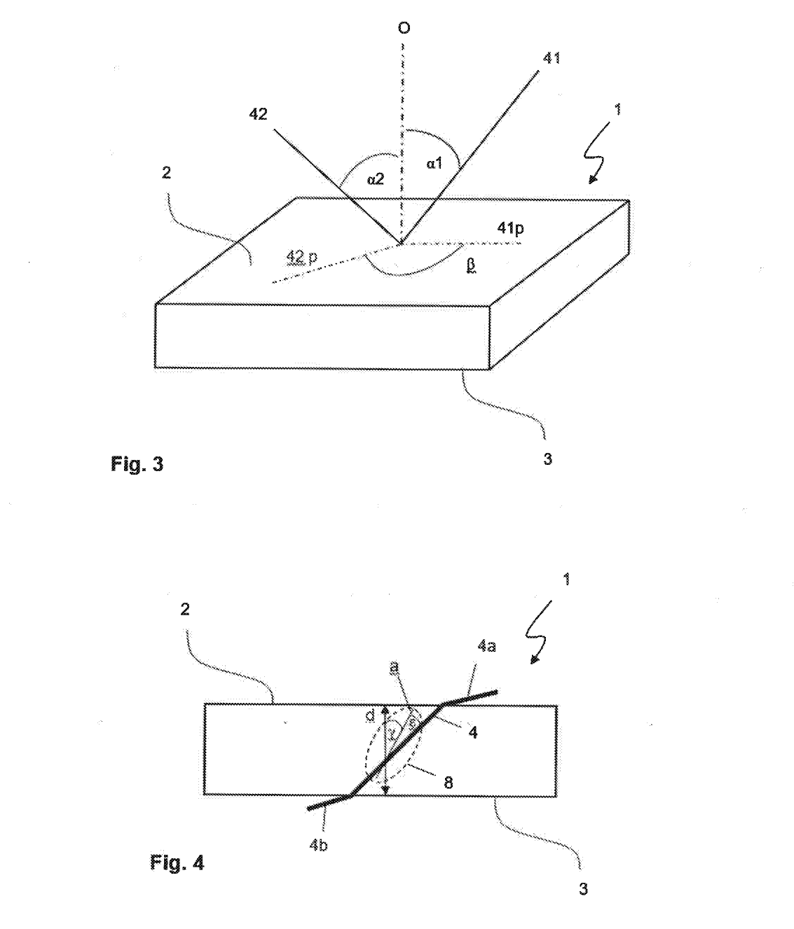

FIG. 3 shows by way of example a schematic diagram of some of the different angles. The molding made of reactive foam (1) shown in FIG. 3 comprises a first fiber (41) and a second fiber (42). In FIG. 3, for better clarity, only the fiber region (FB1) that projects from the first side (2) of the molding is shown for the two fibers (41) and (42). The first fiber (41) forms a first angle α (α1) relative to the orthogonal (O) of the surface of the first side (2) of the molding. The second fiber (42) forms a second angle α (α2) relative to the orthogonal (0) of the surface of the first side (2). The orthogonal projection of the first fiber (41) onto the first side (2) of the molding (41p) forms the angle β with the orthogonal projection of the second fiber (42) onto the first side (2) of the molding (42p).

The reactive foam present in the molding is produced by a double belt foaming process or a block foaming process.

Double belt foaming processes are per se just as well known to those skilled in the art as block foaming processes.

In a double belt foaming process and in a block foaming process an expanded foam is calibrated from at least two sides to obtain the reactive foam.

A double belt foaming process preferably comprises the following steps I-1) to IV-1).
I-1) providing a reactive mixture which comprises at least one first component (K1) and at least one second component (K2), wherein the first component (K1) and the second component (K2) can react with one another,
II-1) introducing the reactive mixture provided in step I-1) between a lower carrier material and an upper carrier material, wherein the reactive mixture rests on the lower carrier material and wherein the upper carrier material rests on the reactive mixture,
III-1) expanding the reactive mixture between the lower carrier material and the upper carrier material to obtain an expanded foam and
IV-1) calibrating the expanded foam obtained in step III-1) between two parallel belts to obtain the reactive foam,

wherein steps III-1) and IV-1) are performed consecutively or simultaneously, preferably simultaneously.

Suitable as the first component (K1) and the second component (K2) that are present in the reactive mixture provided in step I-1) are all first components (K1) and second components (K2) that can react with one another. Such components are known per se to those skilled in the art.

Suitable as the first component (K1) are for example isocyanates. Isocyanates per se are known to those skilled in the art. In the context of the present invention isocyanates are to be understood as meaning all aliphatic, cycloaliphatic and aromatic di- and/or polyisocyanates. Aromatic di- and/or polyisocyanates are preferred. Particularly preferred as the first component (K1) are tolylene diisocyanate (TDI), diphenylmethane diisocyanate (MDI), polymeric diphenylmethane diisocyanates (PMDI) and mixtures thereof. Especially preferred are mixtures of diphenylmethane diisocyanate (MDI) and polymeric diphenylmethane diisocyanates (PMDI) as the first component (K1).

When isocyanates are employed as the first component (K1) these may be fully or partially modified with uretdione, carbamate, isocyanurate, carbodiimide, allophanate and/or urethane groups. It is preferable when they are modified with urethane groups. Such isocyanates are known per se to those skilled in the art.

Also suitable as isocyanates are prepolymers and mixtures of the above-described isocyanates and prepolymers. The prepolymers are produced from the above-described isocyanates and the below-described polyethers, polyesters or mixtures thereof.

Isocyanates suitable as the first component (K1) preferably have an isocyanate index in the range from 100 to 400, particularly preferably in the range from 100 to 300, especially preferably in the range from 100 to 200.

In the context of the present invention the isocyanate index is to be understood as meaning the stoichiometric ratio of isocyanate groups to isocyanate-reactive groups multiplied by 100. Isocyanate-reactive groups are to be understood as meaning all isocyanate-reactive groups present in the reactive mixture including optionally chemical blowing agents and compounds having epoxide groups but not the isocyanate group itself.

As the second component (K2) it is preferable to employ at least one compound having isocyanate-reactive groups. Such compounds are known to those skilled in the art.

Employable as a compound having isocyanate-reactive groups are for example all compounds having at least two isocyanate-reactive groups, such as OH—, SH—, NH— and/or CH-azide groups.

Preferred as the second component (K2) is a compound having isocyanate-reactive groups that is selected from the group consisting of polyether polyols, polyester polyols and polyamines, wherein the at least one compound having isocyanate-reactive groups has a functionality of 2 to 8 and wherein when the second component (K2) is selected from polyether polyols and polyester polyols the at least one compound having isocyanate-reactive groups has an average hydroxyl number of 12 to 1200 mg KOH/g.

Polyether polyols per se are known to those skilled in the art and may be produced by known processes, for example by anionic polymerization of alkylene oxides by addition of at least one starter molecule preferably comprising 2 to 6 reactive hydrogen atoms in bonded form in the presence of catalysts. Employable as catalysts are alkali metal hydroxides such as for example sodium or potassium hydroxide or alkali metal alkoxides such as sodium methoxide, sodium or potassium ethoxide or potassium isopropoxide. In the case of cationic polymerization the catalysts employed are for example Lewis acids such as ammonium pentachloride, boron trifluoride etherate or Fuller's earth. Also employable as catalysts are double metal cyanide compounds, so-called DMC catalysts, and amine-based catalysts.

It is preferable to employ as alkylene oxides one or more compounds having two to four carbon atoms in the alkylene radical, for example ethylene oxide, tetrahydrofuran, 1,2-propylene oxide, 1,3-propylene oxide, 1,2-butylene oxide, 2,3-butylene oxide and mixtures thereof. It is preferable to employ ethylene oxide and/or 1,2-propylene oxide.

Contemplated starter molecules include for example ethylene glycol, diethylene glycol, propylene glycol, dipropylene glycol, glycerol, trimethylolpropane, pentaerythritol, sugar derivatives such as saccharose, hexitol derivatives such as sorbitol, methylamine, ethylamine, isopropylamine, butylamine, benzylamine, aniline, toluidine, toluenediamine, naphthylamine, ethylenediamine, diethylenetriamine, 4,4′-methylenedianiline, 1,3-propanediamine, 1,6-hexanediamine, ethanolamine, diethanolamine, triethanolamine and other divalent or polyvalent alcohols or monovalent or polyvalent amines known to those skilled in the art.

Suitable polyester polyols include all polyester polyols known to those skilled in the art. Suitable polyester polyols are producible for example by condensation of polyfunctional alcohols having two to twelve carbon atoms such as ethylene glycol, diethylene glycol, butanediol, trimethylolpropane, glycerol or pentaerythritol with polyfunctional carboxylic acids having two to twelve carbon atoms, for example succinic acid, glutaric acid, adipic acid, suberic acid, azelaic acid, sebacic acid, decanedicarboxylic acid, maleic acid, fumaric acid, phthalic acid, isophthalic acid, terephthalic acid, the isomers of naphthalenedicarboxylic acids, the anhydrides of the recited acids and mixtures thereof. It is preferable to employ aromatic diacids such as phthalic acid, isophthalic acid and/or terephthalic acid and anhydrides thereof as the acid component and ethylene glycol, diethylene glycol, 1,4-butanediol and/or glycerol as the alcohol component.

Also employable for producing the polyester polyols instead of the polyfunctional carboxylic acids are moreover corresponding monomeric esters such as for example dimethyl terephthalate or polymeric esters, for example polyethylene terephthalate.

Suitable polyamines include all polyamines known to those skilled in the art. Suitable polyamines include both aliphatic polyamines and aromatic polyamines. Preference is given to aliphatic polyamines which in the context of the present invention are also referred to as polyalkylene polyamines.

In the context of the present invention the term “polyalkylene polyamine” is to be understood as meaning aliphatic amines comprising at least three amino groups (primary, secondary or tertiary).

Particularly preferred polyalkylene polyamines are polyethyleneimines. In the context of the present invention “polyethyleneimines” are to be understood as meaning not only oligomers but also homo- and copolymers which comprise the moiety —CH₂—CH₂—NH— and comprise at least three amino groups.

The first component (K1) and the second component (K2) can react with one another. These reactions are known per se to those skilled in the art.

The reaction of the first component (K1) with the second component (K2) forms for example polyurethanes, polyisocyanurates or polyureas, preferably forms polyisocyanates or polyurethanes and most preferably forms polyurethanes. These reactions are known to those skilled in the art.

Polyurethanes are formed for example when isocyanates are used as the first component (K1) and polyether polyols are used as the second component (K2). Polyisocyanurates are formed when isocyanates are used as the first component (K1) and polyester polyols are used as the second component (K2). Polyureas are formed by the reaction of isocyanates as the first component (K1) and polyamines as the second component (K2).

It will be appreciated that polyurethanes may also comprise for example isocyanurate units, allophanate units, urea units, carbodiimide units, biuret units, uretonimine units and optionally further units which may form during addition reactions of isocyanates as the first component (K1). Accordingly, polyisocyanurates may also comprise for example urethane units, allophanate units, urea units, carbodiimide units, biuret units, uretonimine units and optionally further units which may form during addition reactions of isocyanates as the first component (K1). Likewise, polyureas may also comprise for example isocyanurate units, allophanate units, urethane units, carbodiimide units, biuret units, uretonimine units and optionally further units which may form during addition reactions of isocyanates as the first component (K1).

The provision of the reactive mixture in step I-1) may be effected by any methods known to those in the art.

To provide the reactive mixture the first component (K1) and the second component (K2) and any further components and/or catalysts and/or further additives present in the reactive mixture are typically mixed. The mixing is effected for example at a temperature in the range from 15° C. to 130° C., preferably in the range from 15° C. to 90° C., especially preferably in the range from 25° C. to 55° C.

The mixing may be effected by any methods known to those skilled in the art, for example mechanically using a stirrer or a paddle screw or under high pressure in a countercurrent injection process.

The reactive mixture provided in step I-1) may additionally comprise still further components. Further components are for example physical and/or chemical blowing agents. Chemical blowing agents are to be understood as meaning compounds which form gaseous products such as for example water or formic acid upon reaction with isocyanate at the reaction temperatures employed. Physical blowing agents are to be understood as meaning compounds which are dissolved or emulsified in the components of the double belt foaming process of the reactive foam production and which evaporate from the reactive mixture under the conditions of the reaction. These include for example hydrocarbons, halogenated hydrocarbons and other compounds such as for example perfluorinated alkanes such as perfluorohexane, fluorochlorohydrocarbons and ether ester ketones, acetals and inorganic and organic compounds which liberate nitrogen during heating or mixtures thereof, for example (cyclo)aliphatic hydrocarbons having four to eight carbon atoms or fluorohydrocarbons such as 1,1,1,3,3-pentafluoropropane (HFC 245 fa), trifluoromethane, difluoromethane, 1,1,1,3,3-pentafluorobutane (HFC 365 mfc), 1,1,1,2-tetrafluoroethane, difluoroethane and heptafluoropropane.

Advantageously used as blowing agents are low-boiling aliphatic hydrocarbons, preferably n-pentane and/or isopentane, in particular n-pentane, or cycloaliphatic hydrocarbons, in particular cyclopentane.

It is further preferable when the blowing agent comprises water and especially preferable when the blowing agent consists of water.

In addition the reactive mixture may comprise catalysts. Employable catalysts include all compounds which accelerate the reaction of the first component (K1) with the second component (K2). Such compounds are known and described for example in “Kunststoffhandbuch Volume 7, Polyurethane, Karl Hanser Verlag, 3rd Edition 1993, Chapter 3.4.1”.

The reactive mixture provided in step I-1) may moreover comprise further additives. Such additives are known per se to those skilled in the art. Additives are for example stabilizers, interface-active substances, flame retardants or chain extenders.

Stabilizers are also known as foam stabilizers. In the context of the present invention stabilizers are to be understood as meaning substances which promote the formation of a uniform cell structure during foam formation. Suitable stabilizers are for example silicone-containing foam stabilizers such as siloxane-oxyalkylene mixed polymers and other organopolysiloxanes, also alkoxylation products of fatty alcohols, oxoalcohols, fatty amines, alkylphenols, dialkylphenols, alkylcresols, alkylresorcinol, naphthol, alkylnaphthol, naphthylamine, aniline, alkylaniline, toluidine, bisphenol A, alkylated bisphenol A, polyvinyl alcohol and further alkoxylation products of condensation products of formaldehyde and alkylphenols, formaldehyde and dialkylphenols, formaldehyde and alkylcresols, formaldehyde and alkylresorcinol, formaldehyde and aniline, formaldehyde and toluidine, formaldehyde and naphthol, formaldehyde and alkylnaphthol and formaldehyde and bisphenol A or mixtures of two or more of these foam stabilizers.

Interface-active substances are also known as surface-active substances. Interface-active substances are to be understood as meaning compounds which serve to promote homogenization of the starting materials and which may also be suitable to regulate the cell structure of the plastics. These include for example emulsifiers such as sodium salts of castor oil sulfates or of fatty acids and salts of fatty acids with amines, for example diethylamine oleate, diethanolamine stearate, diethanolamine ricinoleate, salts of sulfonic acids, for example alkali metal or ammonium salts of dodecylbenzene- or dinaphthylmethanedisulfonic acid and ricinoleic acid.

Employable flame retardants are for example organic phosphoric and/or phosphonic esters. It is preferable to employ compounds unreactive toward isocyanate groups. Chlorine-comprising phosphoric esters are also included among the preferred compounds. Suitable flame retardants are for example tris(2-chloropropyl) phosphate, triethyl phosphate, diphenyl cresyl phosphate, diethyl ethanephosphinate, tricresyl phosphate, tris(2-chloroethyl) phosphate, tris(1,3-dichloropropyl) phosphate, tris(2,3-dibromopropyl) phosphate, tetrakis(2-chloroethyl) ethylene diphosphate, dimethyl methanephosphonate, diethyl diethanolaminomethylphosphonate and also commercially available halogenated flame retardant polyols.

Also employable for example are bromine-comprising flame retardants. Preferably employed bromine-comprising flame retardants are compounds which are reactive toward the isocyanate group. Such compounds are, for example, esters of tetrabromophthalic acid with aliphatic dials and alkoxylation products of dibromobutenediol. Compounds derived from the group of brominated OH-comprising neopentyl compounds may also be employed.

Also employable for making the polyisocyanate polyaddition products flame resistant apart from the abovementioned halogen-substituted phosphates are for example inorganic or organic flame retardants such as red phosphorus, aluminum oxide hydrate, antimony trioxide, arsenic oxide, ammonium polyphosphate and calcium sulfate, expandable graphite or cyanuric acid derivatives such as for example melamine or mixtures of two flame retardants such as for example ammonium polyphosphates and melamine and optionally maize starch or ammonium polyphosphate, melamine and expandable graphite and/or optionally aromatic polyesters.

Chain extenders are to be understood as meaning difunctional compounds. Such compounds are known per se to those skilled in the art. Suitable chain extenders are for example aliphatic, cycloaliphatic and/or aromatic diols having two to fourteen, preferably two to ten carbon atoms, such as ethylene glycol, 1,2-propanediol, 1,3-propanediol, 1,2-pentanediol, 1,3-pentanediol, 1,10-decanediol, 1,2-dihydroxycyclohexane, 1,3-dihydroxycyclohexane, 1,4-dihydroxycyclohexane, diethyleneglycol, triethylene glycol, dipropylene glycol, tripropylene glycol, 1,4-butanediol, 1,6-hexanediol and bis(2-hydroxyethyl)hydroquinone.

In step II-1) the reactive mixture provided in step I-1) is introduced between a lower and an upper carrier material. The introducing in step II-1) is typically effected on a continuous basis.

In the context of the present invention the introducing of the reactive mixture provided in step I-1) between the upper and the lower carrier material is also referred to as injection. Thus in the context of the present invention the terms “introduction” and “injection” and “introducing” and “injecting” are used synonymously and therefore have the same meaning.

In the context of the the present invention continuous introduction is to be understood as meaning that the reactive mixture is introduced between the lower carrier material and the upper carrier material uniformly and without interruption.

Suitable upper and lower carrier materials are known to those skilled in the art. Aluminum foil, paper, polymer films or nonwovens for example may be employed. It is preferable when the lower carrier material and/or the upper carrier material is a layer (S2). Accordingly, the below-described explanations and preferences for the layer (S2) apply correspondingly to the lower carrier material and the upper carrier material.

It is also preferable when the lower carrier material is the same carrier material as the upper carrier material.

In step III-1) the reactive mixture is expanded between the lower carrier material and the upper carrier material to obtain an expanded foam. The expansion of the reactive mixture is effected by the reaction of the first component (K1) with the second component (K2). Such reactions are known to those skilled in the art. The expansion may be promoted by the chemical and/or physical blowing agent optionally present in the reactive mixture.

The expansion of the reactive mixture may be initiated for example by the catalyst optionally present in the reactive mixture.

The temperature during step III-1) is typically in the range from 20° C. to 250° C., preferably in the range from 30° C. to 180° C., particularly preferably in the range from 30° C. to 110° C. and in particular in the range from 30° C. to 80° C.

During the expansion of the reactive mixture the expanded foam being formed can join with the lower carrier material and/or the upper carrier material. The joining of the lower carrier material and/or the upper carrier material with the expanded foam being formed may be effected for example when the expanded foam penetrates into pores and/or gaps in the lower carrier material and/or in the upper carrier material. It is moreover possible for example that the expanded foam being formed enters into a physical, mechanical or chemical bond with the lower carrier material and/or the upper carrier material. This entering into a bond is known to those skilled in the art.

In the context of the present invention a chemical bond is to be understood as meaning that the expanded foam being formed forms a chemical compound with the lower carrier material and/or with the upper carrier material.

In the context of the present invention a physical bond is to be understood as meaning that the expanded foam being formed and the lower carrier material and/or the upper carrier material are joined to one another only by physical interactions, for example by Van der Waals interactions.

In the context of the present invention a mechanical bond is to be understood as meaning that the expanded foam being formed is mechanically joined to the lower carrier material and/or the upper carrier material, for example through interhooking.

It will be appreciated that combinations of the above-described bonds are also possible.

In step IV-1) the expanded foam obtained in step III-1) is calibrated between two parallel belts to obtain the reactive foam.

This process is known per se to those skilled in the art.

The two parallel belts are preferably arranged above and below the expanded foam, i.e. above the upper carrier material and below the lower carrier material. Thus the calibration in step IV-1) determines the geometric shape of the cross section of the inventive reactive foam in the direction of the lower carrier material and the upper carrier material.

The two parallel belts may for example be temperature controlled, preferably heated.

Steps III-1) and IV-1) may be performed consecutively or simultaneously. They are preferably performed simultaneously. It is therefore preferable when the reactive mixture is expanded between the lower carrier material and the upper carrier material while the obtained expanded foam is simultaneously calibrated between two parallel belts.

Following step IV-1) the lower carrier material and/or the upper carrier material may be removed from the reactive foam. It is preferable when the lower carrier material and/or the upper carrier material are not removed from the reactive foam. It is therefore preferable when the reactive foam produced by a double belt foaming process comprises a lower carrier material and/or an upper carrier material as well as the reactive foam.

The carrier material that has been applied to the reactive foam can improve the stability of the reactive foam during introduction of the fibers. In addition the application of layers, in particular for example of the layer (S2), can be integrated directly into the foam production and, as a result of the reactivity and low-to-moderate viscosity during introduction of the reactive foam, the bonding to the reactive foam can be improved.

A block foaming process is likewise known per se to those skilled in the art. A block foaming process preferably comprises the following steps I-2) to III-2):
I-2) providing a reactive mixture which comprises at least one first component (K1) and at least one second component (K2), wherein the first component (K1) and the second component (K2) can react with one another,
II-2) introducing the reactive mixture provided in step I-2) into a shaping mold, wherein the shaping mold has at least one open side and at least two closed sides and
III-2) expanding the reactive mixture in the shaping mold to obtain the reactive foam.

The above-described explanations and preferences for step I-1) of the double belt foaming process apply correspondingly to step I-2) of the block foaming process.

In step II-2) the reactive mixture provided in step I-2) is introduced into a shaping mold. In the context of the present invention the introduction in step II-2) of the reactive mixture provided in step I-2) into a shaping mold is also referred to as injection. Thus in the context of the present invention the terms “introduction” and “injection” and “introducing” and “injecting” are used synonymously and have the same meaning. According to the invention the shaping mold has at least one open side and at least two closed sides. Such shaping molds are known to those skilled in the art.

It is preferable when the shaping mold comprises a base area and two or more side walls. The side walls, similarly to the base area, are closed sides of the shaping mold. It is especially preferable when the side walls are arranged uniformly and it is preferable when they are aligned orthogonally to the base area. The base area is preferably rectangular. The shaping tool is open in the upward direction, i.e. opposite the base area. In the context of the shaping mold “open” is to be understood as meaning that in step III-2) the reactive mixture can expand freely in this direction. When the shaping mold is open in the upward direction it is also possible for example to have a freely resting lid arranged on the open side. Said lid does not limit the free expansion of the reactive mixture, i.e. the reactive mixture can freely expand in this direction in step III-2).

The shaping mold may comprise carrier and/or separating layers. The carrier and/or separating layers are known to those skilled in the art. The carrier and/or separating layer may be a layer (S2). The below-described explanations and preferences for the layer (S2) apply correspondingly to the carrier and/or separating layer.

The introduction of the reactive mixture provided in step I-2) into the shaping mold is generally effected on a discontinuous basis.

Discontinuous introduction is to be understood as meaning that the introduction of the reactive mixture into the shaping mold is periodically interrupted. As a result the block foaming process affords a plurality of individual slabs of the reactive foam.

In step III-2) the reactive mixture is expanded in the shaping mold to obtain the reactive foam. The expansion of the reactive mixture is effected by the reaction of the first component (K1) with the second component (K2). Such reactions are known to those skilled in the art. The expansion may be promoted by the chemical and/or physical blowing agent optionally present in the reactive mixture.

The expansion of the reactive mixture may be initiated for example by the catalyst optionally present in the reactive mixture.

The temperature of the shaping mold during step III-2) is typically in the range from 20° C. to 200° C., preferably in the range from 30° C. to 140° C., particularly preferably in the range from 30° C. to 110° C. and in particular in the range from 30° C. to 80° C. It is preferable when the temperature of the shaping mold during all of steps I-2) to III-2) of the block foaming process is in the range from 20° C. to 200° C., preferably in the range from 30° C. to 140° C., especially preferably in the range from 30° C. to 80° C.

Following step III-2) the reactive foam obtained in step III-2) may for example be converted, for example by cutting. Processes therefor are known to those skilled in the art.

Based on an orthogonal system of coordinates the length of the reactive foam obtained by the double belt foaming process or the block foaming process is referred to as the x-direction, the width as the y-direction and the thickness as the z-direction.

The reactive foam according to the invention may have any desired dimensions.

The reactive foam produced according to the invention typically has a thickness (z-direction) in the range of at least 10 mm, at least 100 mm, a length (x-direction) of at least 200 mm, preferably of at least 400 mm, and a width (y-direction) of at least 200 mm, preferably of at least 400 mm.

The reactive foam typically has a length (x-direction) of not more than 4000 mm, preferably of not more than 2500 mm, and/or a width (y-direction) of not more than 4000 mm, preferably of not more than 2500 mm.

In addition the reactive foam typically has a thickness (z-direction) of not more than 4000 mm, preferably of not more than 2500 mm.

The above-described dimensions of the reactive foam, i.e. the thickness (z-direction), the width (y-direction) and the length (x-direction) relate to the dimensions of the reactive foam produced by a block foaming process or a double belt foaming process before any optional converting by sawing or cutting for example. The dimensions can change after the converting and the thickness direction (d) can be different from the thickness of the reactive foam directly after the production thereof.

The reactive foam is preferably based on a polyurethane, a polyurea or a polyisocyanurate. The reactive foam is especially preferably based on a polyurethane.

When the reactive foam is based on a polyurethane, a polyurea or a polyisocyanurate this is to be understood as meaning in the context of the present invention that the reactive foam may comprise not only the polyurethane, the polyurea or the polyisocyanurate but also further polymers, for example as a blend of the polyurethane, the polyurea or the polyisocyanurate and a further polymer. Processes for producing these blends are known to those skilled in the art.

When the reactive foam is based on a polyurethane it is also preferable for a polyurethane foam, in particular a rigid polyurethane foam, to be concerned.

It is moreover preferable for the reactive foam to be based on a polyurethane, a polyurea or a polyisocyanurate,
i) wherein the polyurethane, the polyurea or the polyisocyanurate is in each case produced by a double belt foaming process comprising the abovementioned steps I-1) to IV-1) and where the reactive mixture provided in step I-1) comprises as the first component (K1) at least one polyisocyanate and as the second component (K2) at least one compound having isocyanate-reactive groups and as a further component at least one blowing agent or
ii) wherein the polyurethane, the polyurea or the polyisocyanurate is in each case produced by a block foaming process comprising the abovementioned steps I-2) to III-2) and where the reactive mixture provided in step I-2) comprises as the first component (K1) at least one polyisocyanate and as the second component (K2) at least one compound having isocyanate-reactive groups and as a further component at least one blowing agent.

In other words the polyurethane, the polyurea or the polyisocyanate is in each case preferably obtainable by a double belt foaming process comprising the abovementioned steps I-1) to IV-1).

In other words the polyurethane, the polyurea or the polyisocyanate is in each case preferably obtainable by a block foaming process comprising the abovementioned steps I-2) to III-2).

It is most preferred when the reactive foam is based on a polyurethane, a polyurea or a polyisocyanate in each case produced by a double belt foaming process comprising the abovementioned steps I-1) to IV-1) and where the first component (K1) is selected from diphenyl methyl diisocyanate and polymeric diphenylmethane diisocyanates and the second component (K2) is at least one compound having isocyanate-reactive groups selected from the group consisting of polyether polyols, polyester polyols and polyamines, wherein the at least one compound having isocyanate-reactive groups has a functionality of 2 to 8 and wherein when the second component (K2) is selected from polyether polyols and polyester polyols the at least one compound having isocyanate-reactive groups has an average hydroxyl number of 12 to 1200 mg KOH/g and the reactive mixture comprises a further component which comprises at least one blowing agent comprising water or the reactive foam is based on a polyurethane, a polyurea or a polyisocyanate in each case produced by a block foaming process comprising the abovementioned steps I-2) to III-2) and where the first component (K1) is selected from diphenyl methyl diisocyanate and polymeric diphenylmethane diisocyanate and the second component (K2) is at least one compound having isocyanate-reactive groups selected from the group consisting of polyether polyols, polyester polyols and polyamines, wherein the at least one compound having isocyanate-reactive groups has a functionality of 2 to 8 and wherein when the second component (K2) is selected from polyether polyols and polyester polyols the at least one compound having isocyanate-reactive groups has an average hydroxyl number of 12 to 1200 mg KOH/g and the reactive mixture comprises a further component which comprises at least one blowing agent comprising water.

The polymer present in the reactive foam preferably has a glass transition temperature (T_{G}) of at least 80° C., preferably of at least 110° C. and especially preferably of at least 130° C. determined by differential scanning calorimetry (DSC). The glass transition temperature of the polymer present in the reactive foam is generally not more than 400° C., preferably not more than 300° C., in particular not more than 200° C., determined by differential scanning calorimetry (DSC).

Production of the reactive foam by a double belt foaming process or a block foaming process preferably affords an anisotropic reactive foam. This means that a molding where the reactive foam comprises cells and fulfills at least one of the following options is preferred:
i) at least 80%, preferably at least 90%, of the cells are anisotropic, and/or
ii) the ratio of the largest dimension (a-direction) to the smallest dimension (c-direction) of at least 50%, preferably at least 80% and more preferably of at least 90% of the cells is 1.05, preferably in the range from 1.1 to 10, especially preferably in the range from 1.2 to 5, and/or
iii) the mean size of the smallest dimension (c-direction) of at least 50%, preferably at least 80% and more preferably of at least 90% of the cells is in the range from 0.01 to 1 mm, preferably in the range from 0.02 to 0.5 mm and especially preferably in the range from 0.02 to 0.3 mm, and/or
iv) at least 50%, preferably at least 80% and more preferably at least 90% of the cells are orthotropic or transversely isotropic, and/or
v) at least 50%, preferably at least 80% and more preferably at least 90% of the cells based on their largest dimension (a-direction) are aligned at an angle γ of ≤30° or >60° preferably of ≤20° or >70° and more preferably of ≤10° or >80° relative to the thickness direction (d) of the molding, and/or
vi) the reactive foam has a closed-cell content of at least 80%, preferably at least 95%, particularly preferably at least 98%, and/or
vii) the fiber (F) is arranged at an angle ε of ≤60°, preferably of ≤50° relative to the largest dimension (a-direction) of at least 50%, preferably of at least 80% and more preferably of at least 90% of the cells of the reactive foam.

An anisotropic cell has different dimensions in different spatial directions. The largest dimension of the cell is referred to as the “a-direction” and the smallest dimension as the “c-direction”; the third dimension is referred to as the “b-direction”.

The mean size of the smallest dimension (c-direction) of at least 50%, preferably at least 80% and more preferably at least 90% of the cells is typically in the range from 0.01 to 1 mm, preferably in the range from 0.02 to 0.5 mm and in particular in the range from 0.02 to 0.3 mm.

The mean size of the largest dimension (a-direction) of at least 50%, preferably at least 80% and more preferably at least 90% of the cells is typically not more than 20 mm, preferably in the range from 0.01 to 5 mm, in particular in the range from 0.03 to 1 mm and particularly preferably between 0.03 and 0.5 mm.

The dimensions of the cells may be determined, for example, by means of optical micrographs or scanning electron micrographs.

To determine the mean size of the smallest dimension (c-direction) the size of the cells in their smallest dimension is determined as described hereinabove and the values are summed and divided by the number of cells. The mean size of the largest dimension (a-direction) is determined analogously.

An orthotropic cell is to be understood as meaning a special case of an anisotropic cell. Orthotropic means that the cells have three planes of symmetry. In the case where the planes of symmetry are aligned orthogonally to one another based on an orthogonal system of coordinates the dimensions of the cell are different in all three spatial directions, i.e. in the a-direction, in the b-direction and in the c-direction.

Transversely isotropic means that the cells have three planes of symmetry. However, the cells are invariant with respect to rotation about an axis which is the axis of intersection of two planes of symmetry. In the case where the planes of symmetry are aligned orthogonally to one another, only the dimension of the cell in one spatial direction is different to the dimension of the cell in the two other spatial directions. For example, the dimension of the cell in the a-direction is different to that in the b-direction and that in the c-direction, and the dimensions of the cell in the b-direction and in the c-direction are the same.

The closed-cell content of the reactive foam is determined according to DIN ISO 4590 (as per German version of 2003). The closed-cell content describes the volume fraction of closed cells with respect to the total volume of the reactive foam.

The anisotropic properties of the cells of the reactive foam result from the inventive double belt foaming process or the inventive block foaming process. As a result of the reactive mixture being expanded in step III-1) and calibrated in step IV-1) in the double belt foaming process the reactive foam typically obtains anisotropic properties which result from the anisotropic cells. The properties are additionally affected by the expansion properties and the takeoff parameters. If the reactive mixture undergoes very strong expansion between the lower carrier material and the upper carrier material to obtain the expanded foam, said mixture expands in the x-direction for example, i.e. in length, which preferably results in an alignment of the a-direction of the cells relative to the z-direction.

If the expanded foam is for example subjected to rapid takeoff, i.e. rapidly calibrated between the two parallel belts, the a-direction of the cells is preferably aligned in the range from 50° to 130° relative to the z-direction.

The same applies to a reactive foam produced by an inventive block foaming process. As a result of the free expansion of the foam the foam cells are aligned in the rise direction. This results in an anisotropic foam structure and consequently in anisotropic properties.

The angle γ at which at least 50%, preferably at least 80%, more preferably at least 90%, of the cells are aligned based on their largest dimension (a-direction) relative to the thickness direction (d) of the molding is typically at least 0° and at most 90°.

FIG. 4 shows by way of example a schematic diagram of the different angles based on the largest dimension (a-direction) of the cell (8). The molding made of reactive foam (1) shown in FIG. 4 comprises a fiber (4) and a cell (8). For clarity, FIG. 4 shows only one fiber (4) and one cell (8). It will be appreciated that the molding typically comprises more than one cell (8). Relative to the thickness direction (d) of the molding the largest dimension (a) of the cell (8) has an angle γ of ≤45° preferably of ≤30° and more preferably of ≤5°. The fiber (4) has been introduced into the reactive foam at an angle ε of ≤60° preferably of ≤50° relative to the largest dimension (a) of the cell (8).

If the properties of the reactive foam are anisotropic, this means that the properties of the reactive foam differ in different spatial directions. For example the compressive strength of the reactive foam in thickness (z-direction) may be different than in length (x-direction) and/or in width (y-direction).

A molding which fulfills at least one of the following options is therefore also preferred:
i) at least one of the mechanical properties, preferably all of the mechanical properties, of the reactive foam is/are anisotropic, preferably orthotropic or transversely isotropic, and/or
ii) at least one of the elastic moduli, preferably all of the elastic moduli, of the reactive foam behave(s) in the manner of an anisotropic, preferably orthotropic or transversely isotropic, material, and/or
iii) the ratio of the compressive strength of the reactive foam in the z-direction to the compressive strength of the reactive foam in the x-direction is ≥1.1, preferably ≥1.5, especially preferably between 2 and 10, and/or

The term “mechanical properties” is to be understood as meaning all mechanical properties of reactive foams known to those skilled in the art, for example strength, stiffness/elasticity, ductility and toughness.

The elastic moduli are known per se to those skilled in the art. The elastic moduli include, for example, the elastic modulus, the compression modulus, the torsion modulus and the shear modulus.

“Orthotropic” in relation to the mechanical properties/the elastic moduli means that the material has three planes of symmetry. In the case where the planes of symmetry are oriented orthogonally to one another, an orthogonal system of coordinates applies. The mechanical properties/the elastic moduli of the reactive foam thus differ in all three spatial directions, x-direction, y-direction and z-direction.

“Transversely isotropic” in relation to the mechanical properties/the elastic moduli means that the material has three planes of symmetry and the moduli are invariant with respect to rotation about an axis which is the axis of intersection of two planes of symmetry. In the case where the planes of symmetry are oriented orthogonally to one another the mechanical properties/the elastic moduli of the reactive foam in one spatial direction are different to those in the two other spatial directions while those in the two other spatial directions are the same. For example the mechanical properties/the elastic moduli in the z-direction differ from those in the x-direction and in the y-direction while those in the x-direction and in the y-direction are the same.

The compressive strength of the reactive foam of the molding is determined according to DIN EN ISO 844 (as per German version of October 2009).

The compressive strength of the reactive foam in the thickness (z-direction) is typically in the range from 0.05 to 5 MPa, preferably in the range from 0.1 to 2 MPa, particularly preferably in the range from 0.1 to 1 MPa.

The present invention also provides a panel comprising at least one molding according to the invention and at least one layer (S1). A “panel” may optionally also be referred to among specialists in the art as a “sandwich”, “sandwich material”, “laminate” and/or “composite article”.

In a preferred embodiment of the panel the panel comprises two layers (S1) and the two layers (S1) are each attached at a side of the molding that is opposite the respective other side of the molding.

In one embodiment of the panel according to the invention the layer (S1) comprises at least one resin, the resin preferably being a reactive thermosetting or thermoplastic resin, the resin more preferably being based on epoxides, acrylates, polyurethanes, polyamides, polyesters, unsaturated polyesters, vinyl esters or mixtures thereof, the resin in particular being an amine-curing epoxy resin, a latent-curing epoxy resin, an anhydride-curing epoxy resin or a polyurethane composed of isocyanates and polyols. Such resin systems are known to those skilled in the art, for example from Penczek et al. (Advances in Polymer Science, 184, pages 1-95, 2005), Pham et al. (Ullmann's Encyclopedia of Industrial Chemistry, Vol. 13, 2012), Fahnler (Polyamide, Kunststoff Handbuch 3/4, 1998) and Younes (WO12134878 A2).

Also preferred according to the invention is a panel that fulfills at least one of the following options:
i) the fiber region (FB1) of the fiber (F) is in partial or complete contact, preferably complete contact, with the first layer (S1), and/or
ii) the fiber region (FB3) of the fiber (F) is in partial or complete contact, preferably complete contact, with the second layer (S1), and/or
iii) the panel comprises between at least one side of the molding and at least one layer (S1) at least one layer (S2), the layer (S2) preferably being composed of sheetlike fiber materials or polymeric films, more preferably of porous sheetlike fiber materials or porous polymeric films, especially preferably of paper, glass fibers or carbon fibers in the form of nonwovens, non-crimp fabrics or wovens.

Porosity is to be understood as meaning the ratio (dimensionless) of cavity volume (pore volume) to the total volume of a reactive foam. It is determined for example by image analytical evaluation of micrographs by dividing the cavity/pore volume by the total volume. The overall porosity of a substance is made up of the sum of the cavities in communication with one another and with the environment (open porosity) and the cavities not in communication with one another (closed porosity). Preference is given to layers (S2) having a high open porosity.

It is additionally preferable for the at least one layer (S1) of the panel to additionally comprise at least one fibrous material, wherein
i) the fibrous material comprises fibers in the form of one or more plies of chopped fibers, nonwovens, non-crimp fabrics, knits and/or wovens, preferably in the form of non-crimp fabrics or wovens, particularly preferably in the form of non-crimp fabrics or wovens having a basis weight per non-crimp fabric/woven of 150 to 2500 g/m², and/or
ii) the fibrous material comprises fibers of organic, inorganic, metallic or ceramic fibers, preferably polymeric fibers, basalt fibers, glass fibers, carbon fibers or natural fibers, particularly preferably glass fibers or carbon fibers.

The explanations described above apply to the natural fibers and the polymeric fibers.

A layer (S1) additionally comprising at least one fibrous material is also referred to as a fiber-reinforced layer, in particular as a fiber-reinforced resin layer provided that the layer (S1) comprises a resin.

FIG. 2 shows a further preferred embodiment of the present invention. Shown in a two-dimensional side view is a panel (7) according to the invention which comprises a molding (1) according to the invention as detailed hereinabove in the context of the embodiment of FIG. 1 for example. Unless otherwise stated the reference numerals and other abbreviations in FIGS. 1 and 2 have the same meanings,

In the embodiment according to FIG. 2, the panel according to the invention comprises two layers (S1) represented by (5) and (6). The two layers (5) and (6) are thus each on mutually opposite sides of the molding (1). The two layers (5) and (6) are preferably resin layers or fiber-reinforced resin layers. As is further apparent from FIG. 2, the two ends of the fiber (4) are surrounded by the respective layers (5) and (6).

One or more further layers may also optionally be present between the molding (1) and the first layer (5) and/or between the molding (1) and the second layer (6). As described hereinabove for FIG. 1, for simplicity FIG. 2 also shows only a single fiber (F) (numeral (4)). With regard to the number of fibers or fiber bundles in practice, that which is recited above for FIG. 1 applies analogously.

Also preferred is a panel where at least one of the following alternatives is fulfilled:
i) the molding present in the panel comprises at least one side that has not been subjected to mechanical and/or thermal processing, and/or
ii) the panel comprises between at least one side and at least one layer (S1) at least one layer (S2), wherein the at least one layer (S2) was applied to the reactive foam of the molding of the panel as the upper carrier material and/or as the lower carrier material in step II-1) of the double belt foaming process, and/or
iii) the at least one layer (S1) comprises a resin and the reactive foam of the molding of the panel has a surface resin absorption of ≤2000 g/m², preferably of ≤1000 g/m², more preferably of ≤500 g/m² and most preferably of ≤100 g/m², and/or
iv) the panel has a peel strength of ≥200 J/m², preferably of ≥500 J/m², particularly preferably of ≥2000 J/m², and/or
v) the reactive foam of the molding present in the panel has a shear modulus measured parallel to the at least one layer (S1) in the range from 0.05 to 0.6 MPa/(kg/m³), preferably in the range from 0.05 to 0.5 MPa/(kg/m³), particularly preferably in the range from 0.05 to 0.2 MPa/(kg/m³), and/or
vi) the molding present in the panel has in the panel a specific shear strength measured parallel to the at least one layer (S1) of at least 5 kPa/(kg/m³), preferably of at least 8 kPa/(kg/m³), particularly preferably of at least 12 kPa/(kg/m³), and/or
vii) the molding present in the panel has in the panel a shear modulus measured parallel to the at least one layer (S1) of at least 0.2 MPa/(kg/m³), preferably of at least 0.6 MPa/(kg/m³), particularly preferably of at least 1.0 MPa/(kg/m³).

The specific shear strength and the shear modulus are determined according to DIN 53294 (1982 version) and the density according to ISO 845 (2007 version).

The shear modulus of the molding according to alternative v) relates to the tensile modulus of the reactive foam of the molding without the at least one layer (S1) and without the fiber (F). Only the measurement is effected parallel to the side at which in the panel the at least one layer (S1) is applied.

The peel strength of the panel is determined with single cantilever beam (SCB) samples. The thickness of the moldings is 20 mm and the layers (S1) are composed of quasi-isotropic glass fiber-reinforced epoxy resin layers each of about 2 mm in thickness. The panels are then tested in a Zwick Z050 tensile tester at a speed of 5 mm/min, the panel being loaded and unloaded three to four times. Crack propagation/growth is determined by visual assessment for each load cycle (Δa). The force-distance plot is used to ascertain the crack propagation energy (ΔU). This is used to ascertain the crack resistance or peel strength as

$${G}_{IC} = \frac{Δ U}{B Δ a}$$

where B is sample width.

Also preferred according to the invention is a panel where the side of the molding to which the at least one layer (S1) has been applied has a surface resin absorption of ≤2000 g/m², preferably of ≤1000 g/m², particularly preferably of ≤500 g/m², especially preferably of ≤100 g/m², and that at least one surface, preferably all surfaces, of the molding orthogonal to the side of the molding to which the at least one layer (S1) has been applied has a surface resin absorption which differs from the surface resin absorption of the side of the molding to which the at least one layer (S1) has been applied by at least 10%, preferably by at least 20%, especially preferably by at least 50%.

Resin absorption is determined using not only the employed resin systems, the reactive foam and glass non-crimp fabrics but also the following auxiliary materials: nylon vacuum film, vacuum sealing tape, nylon flow aid, polyolefin separation film, polyester tearoff fabric and PTFE membrane film and polyester absorption fleece. Panels, also referred to hereinafter as sandwich materials, are produced from the moldings by applying fiber-reinforced outer plies by means of vacuum infusion. Applied to each of the top side and the bottom side of the (fiber-reinforced) foams are two plies of Quadrax glass non-crimp fabric (roving: E-Glass SE1500, OCV; textile: saertex, isotropic laminate [0°/−45°/90°45°] of 1200 g/m² in each case). For the determination of the resin absorption, a separation film is inserted between the molding, also referred to hereinafter as core material, and the glass non-crimp fabrics, in contrast with the standard production of the panels. The resin absorption of the pure molding is thus determinable. The tearoff fabric and the flow aids are attached on either side of the glass non-crimp fabrics. The construction is subsequently equipped with gates for the resin system and gates for the evacuation. Finally, a vacuum film is applied over the entire construction and sealed with sealing tape, and the entire construction is evacuated. The construction is prepared on an electrically heatable table having a glass surface.

The resin system used is amine-curing epoxy (resin: BASF Baxxores 5400, curing agent: BASF Baxxodur 5440, mixing ratio and further processing as per data sheet). After the mixing of the two components the resin is evacuated at down to 20 mbar for 10 minutes. Infusion onto the pre-temperature-controlled construction is effected at a resin temperature of 23+/−2° C. (table temperature: 35° C.). A subsequent temperature ramp of 0.3 K/min from 35° C. to 75° C. and isothermal curing at 75° C. for 6 h allows production of panels consisting of the reactive foams and glass fiber-reinforced outer plies.

At the start, the moldings are analyzed according to ISO 845 (October 2009 version), in order to obtain the apparent density of the foam. After curing of the resin system the processed panels are trimmed in order to eliminate excess resin accumulations in the edge regions as a result of imperfectly fitting vacuum film.

The outer plies are then removed and the moldings present are reanalyzed by ISO 845. The difference in the densities gives the absolute resin absorption. Multiplication by the thickness of the molding gives the corresponding resin absorption in kg/m².

The present invention further provides a process for producing the molding according to the invention, wherein at least one fiber (F) is partially introduced into the reactive foam with the result that the fiber (F) is with the fiber region (FB2) arranged inside the molding and surrounded by the reactive foam while the fiber region (FB1) of the fiber (F) projects from a first side of the molding and the fiber region (FB3) of the fiber (F) projects from a second side of the molding.

Suitable methods of introducing the fiber (F) and/or a fiber bundle are in principle all those known to those skilled in the art. Suitable processes are described, for example, in WO 2006/125561 or in WO 2011/012587.

In one embodiment of the process according to the invention the partial introduction of the at least one fiber (F) into the reactive foam is effected by sewing-in using a needle, partial introduction preferably being effected by steps a) to f):
a) optionally applying at least one layer (S2) to at least one side of the reactive foam,
b) producing one hole per fiber (F) in the reactive foam and optionally in the layer (S2), wherein the hole extends from a first side to a second side of the reactive foam and optionally through the layer (S2),
c) providing at least one fiber (F) on the second side of the reactive foam,
d) passing a needle from the first side of the reactive foam through the hole to the second side of the reactive foam and optionally passing the needle through the layer (S2),
e) securing at least one fiber (F) to the needle on the second side of the reactive foam and
f) returning the needle including the fiber (F) through the hole, so that the fiber (F) is with the fiber region (FB2) arranged inside the molding and surrounded by the reactive foam while the fiber region (FB1) of the fiber (F) projects from a first side of the molding or optionally of the layer (S2) and the fiber region (FB3) of the fiber (F) projects from a second side of the molding,

simultaneous performance of steps b) and d) being particularly preferred.

The applying of the at least one layer (S2) onto at least one side of the reactive foam in step a) may for example be effected during step II-1) of the double belt foaming process as described hereinabove. In this case the layer (S2) is the lower carrier material and/or the upper carrier material.

It is likewise possible for example that the at least one layer (S2) is applied to at least one side of the reactive foam in step a) during step II-2) and step III-2) of the block foaming process when the shaping mold in step II-2) comprises carrier and/or separating layers.

In a particularly preferred embodiment steps b) and d) are performed simultaneously. In this embodiment the hole from the first side to the second side of the reactive foam is produced by passing a needle from the first side of the reactive foam to the second side of the reactive foam.

In this embodiment the introduction of the at least one fiber (F) may comprise for example the following steps:
a) optionally applying a layer (S2) to at least one side of the reactive foam,
b) providing at least one fiber (F) on the second side of the reactive foam,
c) producing one hole per fiber (F) in the reactive foam and optionally in the layer (S2), wherein the hole extends from the first side to a second side of the reactive foam and optionally through the layer (S2) and wherein the hole is produced by passing a needle through the reactive foam and optionally through the layer (S2),
d) securing at least one fiber (F) to the needle on the second side of the reactive foam,
e) returning the needle including the fiber (F) through the hole, so that the fiber (F) is with the fiber region (FB2) arranged inside the molding and surrounded by the reactive foam while the fiber region (FB1) of the fiber (F) projects from a first side of the molding or optionally from the layer (S2) and the fiber region (FB3) projects from a second side of the molding,
f) optionally cutting off the fiber (F) on the second side and
g) optionally cutting open the loop of the fiber (F) formed at the needle.

In a preferred embodiment, the needle used is a hook needle and at least one fiber (F) is hooked into the hook needle in step d).

In a further preferred embodiment a plurality of fibers (F) are introduced into the reactive foam according to the above-described steps simultaneously.

In the process according to the invention it is additionally preferable when depressions in the molding are introduced into the reactive foam partially or completely before the introduction of at least one fiber (F).

The present invention further provides a process for producing the panel according to the invention, in which the at least one layer (S1) is produced, applied and cured on a molding according to the invention in the form of a reactive viscous resin, preferably by liquid impregnation methods, particularly preferably by pressure- or vacuum-assisted impregnation methods, especially preferably by vacuum infusion or pressure-assisted injection methods, most preferably by vacuum infusion. Liquid impregnation methods are known as such to those skilled in the art and are described in detail, for example, in Wiley Encyclopedia of Composites (2nd Edition, Wiley, 2012), Parnas et al. (Liquid Composite Moulding, Hanser, 2000) and Williams et al. (Composites Part A, 27, p. 517-524, 1997).

Various auxiliary materials can be used for producing the panel according to the invention. Suitable auxiliary materials for production by vacuum infusion include, for example, vacuum film, preferably made of nylon, vacuum sealing tape, flow aids, preferably made of nylon, separation film, preferably made of polyolefin, tearoff fabric, preferably made of polyester, and a semipermeable film, preferably a membrane film, particularly preferably a PTFE membrane film, and absorption fleece, preferably made of polyester. The choice of suitable auxiliary materials is guided by the component to be manufactured, the process chosen and the materials used, specifically the resin system. When employing resin systems based on epoxide and polyurethane it is preferable to use flow aids made of nylon, separation films made of polyolefin, tearoff fabric made of polyester and a semipermeable films as PTFE membrane films and absorption fleeces made of polyester.

These auxiliary materials can be used in various ways in the processes for producing the panel according to the invention. It is particularly preferable when panels are produced from the moldings by applying fiber-reinforced outer plies by means of vacuum infusion. In a typical construction, to produce the panel according to the invention, fibrous materials and optionally further layers are applied to the top side and the bottom side of the moldings. Subsequently, tearoff fabric and separation films are positioned. The infusion of the liquid resin system may be carried out using flow aids and/or membrane films. Particular preference is given to the following variants:
i) use of a flowaid on just one side of the construction, and/or
ii) use of a flow aid on both sides of the construction, and/or
iii) construction with a semipermeable membrane (VAP construction); the latter is preferably draped over the full area of the molding, on which flow aids, separation film and tearoff fabric are used on one or both sides, and the semipermeable membrane is sealed with respect to the mold surface by means of vacuum sealing tape, the absorption fleece is inserted on the side of the semipermeable membrane remote from the molding, as a result of which the air is evacuated upward over the full area, and/or
iv) use of a vacuum pocket made from membrane film, which is preferably positioned at the opposite gate side of the molding, by means of which the air is evacuated from the opposite side to the gate.

The construction is subsequently equipped with gates for the resin system and gates for the evacuation. Finally, a vacuum film is applied over the entire construction and sealed with sealing tape, and the entire construction is evacuated. After the infusion of the resin system, the reaction of the resin system takes place with maintenance of the vacuum.

The present invention also provides for the use of the molding according to the invention or of the panel according to the invention for rotor blades in wind turbines, in the transport sector, in the construction sector, in automobile construction, in shipbuilding, in rail vehicle construction, for container construction, for sanitary installations and/or in aerospace.

The present invention is more particularly elucidated hereinbelow with reference to examples without being limited thereto.

### EXAMPLES

Characterization

The properties of the reactive foams, of the moldings and of the panels are determined as follows:

Anisotropy:

To determine anisotropy micrographs of the cells of the middle region of the reactive foams are subjected to statistical evaluation. The largest dimension of the cell is referred to as the “a-direction”, and the two other dimensions oriented orthogonally thereto (b-direction and c-direction) result therefrom. Anisotropy is calculated as the quotient of the a-direction and the c-direction.

Orientation of the a-direction of the cell relative to the thickness direction (d); angle γ:

The orientation of the a-direction of the cell is likewise evaluated by means of micrographs. The angle enclosed between the a-direction and the thickness direction (d) of the molding gives the orientation.

Smallest dimension of the cell (c-direction):

The smallest dimension of the cells is determined by statistical analysis of the micrographs analogously to anisotropy.

Compressive strength along the z-direction and along the a-direction:

Compressive strength is determined in accordance with DIN EN ISO 844 (as per German version October 2009).

Ratio of compressive strength of the reactive foam along the z-direction to the compressive strength of the reactive foam along the x-direction (compressive strength z/x):

The ratio of compressive strength along the z-direction to the compressive strength in the x-direction is determined by the quotient of the two individual values.

Density:

The density of the pure reactive foams is determined according to ISO 845 (October 2009 version).

Resin absorption:

For resin absorption reactive foams are compared after removal of material from the surface by planing. In addition to the employed resin systems, the foam slabs and glass non-crimp fabrics, the following auxiliary materials are used: nylon vacuum film, vacuum sealing tape, nylon flow aid, polyolefin separation film, polyester tearoff fabric and PTFE membrane film and polyester absorption fleece. Panels are produced from the moldings by applying fiber-reinforced outer plies by means of vacuum infusion. Applied to each of the top side and the bottom side of the reactive foams are two plies of Quadrax glass non-crimp fabric (roving: E-Glass SE1500, OCV; textile: saertex, isotropic laminate [0°/−45°/90° 45°] of 1200 g/m² in each case). For the determination of the resin absorption a separation film is inserted between the reactive foam and the glass non-crimp fabric, in contrast with the standard production of the panels. The resin absorption of the pure reactive foam is thus determinable. The tearoff fabric and the flow aids are attached on either side of the glass non-crimp fabrics. The construction is subsequently equipped with gates for the resin system and gates for the evacuation. Finally, a vacuum film is applied over the entire construction and sealed with sealing tape, and the entire construction is evacuated. The construction is prepared on an electrically heatable table having a glass surface.

The resin system used is amine-curing epoxy (resin: BASF Baxxores 5400, curing agent: BASF Baxxodur 5440, mixing ratio and further processing as per data sheet). After the mixing of the two components the resin is evacuated at down to 20 mbar for 10 minutes. Infusion onto the pre-temperature-controlled construction is effected at a resin temperature of 23+/−2° C. (table temperature: 35° C.). By means of a subsequent temperature ramp of 0.3 K/min from 35° C. to 75° C. and isothermal curing at 75° C. for 6 h, it is possible to produce panels consisting of the moldings and glass fiber-reinforced outer plies.

The foams are initially analyzed according to ISO 845 (October 2009 version) to obtain the apparent density of the foam. After curing of the resin system the processed panels are trimmed in order to eliminate excess resin accumulations in the edge regions as a result of imperfectly fitting vacuum film.

The outer plies are then removed and the reactive foams present are reanalyzed according to ISO 845. The difference in the densities gives the absolute resin absorption. Multiplication by the thickness of the reactive foam then gives the corresponding resin absorption in kg/m².

Shear stiffness and strength of the panels:

The shear properties of the panels are determined according to DIN 53294 at 23° C. and 50% relative humidity (February 1982 version).

Crease resistance of the panels:

Resistance to creasing of the outer plies (microwrinkling) is determined by arithmetic means based on measured basic properties of the material. The buckling resistance against creasing of the outer plies is determinable as σ_{c}=0.85 ·⁸\sqrt{E_{c3}·E_{f}·G_{c}}

where E_{c3}: core stiffness in thickness direction, E_{f}: stiffness of the outer layer, G_{c}: shear stiffness of the core material.

Resin absorption

Resin absorption is determined from the produced panels by arithmetic means using the densities/thicknesses of the reactive foam and of the trimmed panel.

### Example B1

Double Belt Foaming Process

a) Production of the Reactive Foam

The reactive foam was produced by a continuous double belt foaming process. The plant consists of an upper conveyor belt and a lower conveyor belt. The reactive mixture was continuously injected between a lower carrier material and an upper carrier material via a high-pressure mixing head. The lower carrier material consisted of an aluminum foil and the upper carrier material consisted of an aluminum foil. The reactive mixture was subsequently expanded and calibrated between the lower conveyor belt and the upper conveyor belt. The obtained reactive foam was cut into sheets. The sheet thickness was 50 mm. Before reinforcement with the at least one fiber (F) and thus before production of the molding the upper carrier material and the lower carrier material were taken off and the sheets were planed down to 20 mm for further processing. The reactive mixture comprises 10 000 parts by mass of the polyol component Elastopor® H 1131/90, 15 000 parts by mass of isocyanate component Lupranat® M 50, as well as the additives of in each case 8 parts by mass of water, 550 parts by mass of pentane and 570 parts by mass of dimethylcyclohexylamine.

b) Production of the Molding

The reactive foam is reinforced with glass fibers (rovings, E-Glas, 900 tex, 3B). The glass fibers are introduced in the form of rovings at an angle α of 45° in four different spatial directions at an angle β of 90° to one another. The glass fibers have been introduced in a regular pattern with equal distances a₁=a₂=16 mm. In addition, on the first side and the second side the glass fibers are left to overhang by about 5.5 mm to improve the bonding to the glass fiber mats introduced later as outer plies. The fibers/fiber rovings are introduced in an automated manner by a combined sewing/crochet process. Initially, a hook needle (diameter about 1.1 mm) is used to completely pierce the reactive foam from the first side to the second side. On the second side a roving is hooked into the hook of the hook needle and then pulled by the needle from the second side through the hole and back to the first side of the reactive foam. Finally, the roving is cut off on the second side and the formed roving loop is cut open at the needle. The hook needle is thus ready for the next sewing operation.

c) Production of the Panel

Subsequently, panels are produced from the moldings by application of fiber-reinforced outer plies by means of vacuum infusion as described hereinabove for determination of resin absorption. However, in contrast to the determination of resin absorption no separation film is introduced between the molding and the glass non-crimp fabrics for production of the panel.

### Example B2

Block Foaming Process

a) Production of the Reactive Foam

The reactive foam was produced by a discontinuous block foaming process. The plant consists of a block mold where the bottom and the side walls are closed and the top side of the mold is open. The reactive mixture was mixed by a high-pressure mixing head and filled into the shaping mold. The mixture then expands and reacts inside the shaping mold. The obtained reactive foam block is then cooled and cut into sheets orthogonally to the expansion direction. The reactive mixture for producing the reactive foam comprised the following components: saccharose-based polyether polyol (31 parts by mass, functionality 4.5, number-average molecular weight 515 g/mol, viscosity 8000 mPa.s at 25° C.), phthalic anhydride-diethylene glycol-based polyester polyol (28 parts by mass, functionality 2, number-average molecular weight 360 g/mol), propylene glycol-based chain extender (10 parts by mass, functionality 2, number-average molecular weight 134 g/mol), propylene glycol-based chain extender (28 parts by mass, functionality 2, number-average molecular weight 190 g/mol), water (1.45 parts by mass), tertiary aliphatic amine as catalyst (0.07 parts by mass), silicone-based stabilizer (2.0 parts by mass), polymeric MDI (183 parts by mass, viscosity 200 mPa.s at 25° C.).

Production of the moldings and of the panel is carried out analogously to example B1.

### Example B3

Block Foaming Process

a) Production of the Foam

The production of the foam is carried out analogously to example B2. However, the sheet is not cut orthogonally to the expansion direction but rather parallel to the expansion direction.

Production of the moldings and of the panels is carried out analogously to example B1,

Table 1 shows the results for the reactive foams, the moldings and the panels of example B1, example B2 and example B3.

TABLE 1

| | | | B1 | B2 | B3 |
|---|---|---|---|---|---|
| Reactive | Production process | (—) | double | block | block |
| foam | | | belt | | |
| | Polymer | (—) | PU | PU | PU |
| | Anisotropy of cell primary axes | (—) | 1.2 | 1.1 | 1.1 |
| | γ | (°) | 90 | 0 | 90 |
| | c-direction | (mm) | 0.09 | 0.21 | 0.21 |
| | Compressive strength along a-direction | (MPa) | 0.40 | 0.27 | 0.27 |
| | Compressive strength along z-direction | (MPa) | 0.17 | 0.27 | 0.27 |
| | Compressive strength z/x | (—) | 0.4 | 1.3 | 1.3 |
| | Thickness | (mm) | 20 | 20 | 20 |
| | Resin absorption on area parallel to | (kg/m²) | 0.70 | 0.80 | 0.80 |
| | a-direction | | surface | lateral | surface |
| | | | | face | |
| | Resin absorption on surface | (kg/m²) | 0.46 | 0.71 | 0.71 |
| | orthogonal to a-direction | | lateral | surface | lateral |
| | | | face | | face |
| | Density | (kg/m³) | 46 | 47 | 47 |
| | Compressive strength in thickness | (kPa/(kg/m³)) | 3.6 | 5.7 | 4.4 |
| | direction (d) to density | | | | |
| Molding | Fiber introduction method | (—) | hook | hook | hook |
| | | | needle | needle | needle |
| | Fiber material | (—) | E-glass | E-glass | E-glass |
| | Fiber thickness | (tex) | 900 | 900 | 900 |
| | α | (°) | 45 | 45 | 45 |
| | β | (°) | 90 | 90 | 90 |
| | Number of fiber orientations | (—) | 4 | 4 | 4 |
| | Distance of fibers (a₁ × a₂) | (mm × mm) | 16 × 16 | 16 × 16 | 16 × 16 |
| | Fiber region (FB2)/overall fiber (F) | (%) | 72 | 72 | 72 |
| | Number of fiber bundles | (1/m²) | 15.625 | 15.625 | 15.625 |
| | Introduction of slots | (—) | no | no | no |
| | Application of further layers (S2) | (—) | no | no | no |
| Panel | Layer application | (—) | VI | VI | VI |
| | Layer construction | (—) | epoxy/ | epoxy/ | epoxy/ |
| | | | E-glass | E-glass | E-glass |
| | | | fiber | fiber | fiber |
| | Shear stiffness | (MPa) | 166 | — | — |
| | Shear resistance | (MPa) | 2.3 | — | — |
| | Peel strength | (kJ/m²) | — | — | — |
| | Crease resistance* | (MPa) | 57 | 70 | 59 |
| | Resin absorption by foam surface | (kg/m²) | 0.46 | 0.80 | 0.71 |
| | (without pins) | | | | |
| | Resin absorption* | (kg/m²) | 1.8 | 2.3 | 2.2 |

*arithmetically determined values

The reactive foams produced according to the invention and thus also the moldings according to the invention and the panels produced therefrom feature a good anisotropy. Anisotropy also allows other properties to be controlled.

In example B1 and example B3 the a-direction of the cells is orientated orthogonally to the thickness direction (d) of the reactive foam/of the molding. This results in a low surface resin absorption compared to the resin absorption of the lateral faces which are orthogonal to the surface. The panel also has a very low density.

By contrast in example B2 the a-directions of the cells are oriented orthogonal to the surface of the reactive foam/of the molding and thus form with the thickness direction (d) an angle γ of 0°. This results in a slightly higher resin absorption at the surface but also in better mechanical properties in the thickness direction (d). In addition, the produced panels have a good crease resistance.

1.-15. (canceled)

16. A molding made of reactive foam, wherein at least one fiber (F) is with a fiber region (FB2) arranged inside the molding and surrounded by the reactive foam while a fiber region (FB1) of the fiber (F) projects from a first side of the molding and a fiber region (FB3) of the fiber (F) projects from a second side of the molding, wherein the reactive foam has been produced by a double belt foaming process or a block foaming process, wherein the reactive foam comprises cells, wherein at least 50% of the cells are anisotropic, wherein at least one of the mechanical properties of the reactive foam is anisotropic.

17. The molding according to claim 16, wherein the double belt foaming process comprises the following steps I-1) to IV-1):
I-1) providing a reactive mixture which comprises at least one first component (K1) and at least one second component (K2), wherein the first component (K1) and the second component (K2) can react with one another,
II-1) introducing the reactive mixture provided in step I-1) between a lower carrier material and an upper carrier material, wherein the reactive mixture rests on the lower carrier material and wherein the upper carrier material rests on the reactive mixture,
III-1) expanding the reactive mixture between the lower carrier material and the upper carrier material to obtain an expanded foam and
IV-1) calibrating the expanded foam obtained in step III-1) between two parallel belts to obtain the reactive foam,
wherein steps III-1) and IV-1) are performed consecutively or simultaneously.

18. The molding according to claim 16, wherein the block foaming process comprises the following steps I-2) to III-2):
I-2) providing a reactive mixture which comprises at least one first component (K1) and at least one second component (K2), wherein the first component (K1) and the second component (K2) can react with one another,
II-2) introducing the reactive mixture provided in step I-2) into a shaping mold, wherein the shaping mold has at least one open side and at least two dosed sides and
III-2) expanding the reactive mixture in the shaping mold to obtain the reactive foam,

19. The molding according to claim 17, wherein the reactive foam is based on a polyurethane, a polyurea or a polyisocyanurate,
wherein the polyurethane, the polyurea or the polyisocyanurate is in each case produced by the double belt foaming process and where the reactive mixture provided in step I-1) comprises as the first component (K1) at least one polyisocyanate and as the second component (K2) at least one compound having isocyanate-reactive groups and as a further component at least one blowing agent.

20. The molding according to claim 16, wherein the reactive foam comprises cells, wherein
i) at least 80% of the cells are anisotropic, and/or
ii) the ratio of the largest dimension (a-direction) to the smallest dimension (c-direction) of at least 50% of the cells is ≥1.05, and/or
iii) the mean size of the smallest dimension (c-direction) of at least 50% of the cells is in the range from 0.01 to 1 mm, and/or
iv) at least 50% of the cells are orthotropic or transversely isotropic, and/or
v) at least 50% of the cells based on their largest dimension (a-direction) are aligned at an angle γ of ≤30° or >60° relative to the thickness direction (d) of the molding, and/or
vi) the reactive foam has a closed-cell content of at least 80%, and/or
vii) the fiber (F) is arranged at an angle ε of ≤60° relative to the largest dimension (a-direction) of at least 50% of the cells of the reactive foam.

21. The molding according to claim 16, wherein
i) the reactive foam has a thickness (z-direction) in the range of at least 10 mm, a length (x-direction) of at least 200 mm, and a width (y-direction) of at least 200 mm, and/or
ii) the surface of at least one side of the molding has at least one depression, the depression being a slot or a hole, and/or
iii) all of the mechanical properties of the reactive foam are anisotropic, and/or
iv) at least one of the elastic moduli of the reactive foam behave(s) in the manner of an anisotropic material, and/or
(v) the ratio of the compressive strength of the reactive foam in thickness (z-direction) to the compressive strength of the reactive foam in strength (x-direction) is ≥1.1, and/or
(vi) the polymer present in the reactive foam has a glass transition temperature (T_{G}) of at least 80° C., and/or
vii) the fiber (F) is a single fiber or a fiber bundle, and/or
viii) the fiber (F) is an organic, inorganic, metallic or ceramic fiber or a combination thereof, and/or
ix) the fiber (F) is employed in the form of a fiber bundle having a number of individual fibers per bundle of at least 10 in the case of glass fibers and 1000 to 50 000 in the case of carbon fibers, and/or
x) the fiber region (FB1) and the fiber region (FB3) each independently of one another account for 1% to 45% and the fiber region (FB2) accounts for 10% to 98% of the total length of a fiber (F), and/or
xi) the fiber (F) has been introduced into the reactive foam at an angle α, of 0° to 60° or of 10° to 70° relative to the thickness direction (d) of the molding, and/or
(xii) in the molding the first side of the molding from which the fiber region (FB1) of the fiber (F) projects is opposite the second side of the molding from which the fiber region (FB3) of the fiber (F) projects, and/or
(viii) the molding comprises a multiplicity of fibers (F) and/or comprises more than 10 fibers (F) per m²,

22. A panel comprising at least one molding according to claim 16 and at least one layer (S1).

23. The panel according to claim 22, wherein the layer (S1) comprises at least one resin.

24. The panel according to claim 23, wherein the layer (S1) additionally comprises at least one fibrous material, wherein
i) the fibrous material comprises fibers in the form of one or more laminas of chopped fibers, webs, scrims, knits and/or weaves, and/or
ii) the fibrous Material comprises organic, inorganic, metallic or ceramic fibers.

25. The panel according to claim 22, wherein the panel has two layers (S1) and the two layers (S1) are each mounted on a side of the molding opposite the respective other side in the molding.

26. A panel comprising at least one molding according to claim 17 and at least one layer (S1) wherein
i) the fiber region (FB1) of the fiber (F) is in partial or complete contact with the first layer (S1), and/or
ii) the fiber region (FB3) of the fiber (F) is in partial or complete contact with the second layer (S1), and/or
iii) the panel comprises between at least one side of the molding and at least one layer (S1) at least one layer (S2), the layer (S2) being composed of sheetlike fiber materials or polymeric films, and/or
iv) the panel comprises between at least one side and at least one layer (S1) at least one layer (S2), wherein the at least one layer (S2) was applied to the reactive foam of the molding of the panel as the upper carrier material and/or as the lower carrier material in step II-1) of the double belt foaming process, and/or
v) the molding present in the panel comprises at least one side that has not been subjected to mechanical and/or thermal processing.

27. A process for producing a molding according to claim 16, wherein at least one fiber (F) is partially introduced into the reactive foam with the result that the fiber (F) is with the fiber region (FB2) arranged inside the molding and surrounded by the reactive foam while the fiber region (FB1) of the fiber (F) projects from a first side of the molding and the fiber region (FB3) of the fiber (F) projects from a second side of the molding.

28. The process according to claim 27, wherein the partial introduction of at least one fiber (F) into the reactive foam is effected by sewing-in using a needle, partial introduction being effected by steps a) to f):
a) optionally applying at least one layer (S2) to at least one side of the reactive foam,
b) producing one hole per fiber (F) in the reactive foam, wherein the hole extends from a first side to a second side of the reactive foam and optionally through the layer (S2),
c) providing at least one fiber (F) on the second side of the reactive foam,
d) passing a needle from the first side of the molding through the hole to the second side of the reactive foam and optionally passing the needle through the layer (S2),
e) securing at least one fiber (F) to the needle on the second side of the reactive foam and returning the needle including the fiber (F) through the hole, so that the fiber (F) is with the fiber region (FB2) arranged inside the molding and surrounded by the reactive foam while the fiber region (FB1) of the fiber (F) projects from a first side of the molding and the fiber region (FB3) of the fiber (F) projects from a second side of the molding,
wherein steps b) and d) are optionally performed simultaneously.

29. A process for producing a panel according to claim 22, wherein the at least one layer (S1) is produced, applied and cured on the at least one molding in the form of a reactive viscous resin, by liquid impregnation methods.

30. A rotor blade in a wind turbine comprising the molding according to claim 16.

31. The molding according to claim 18, wherein the reactive foam is based on a polyurethane, a polyurea or a polyisocyanurate,
wherein the polyurethane, the polyurea or the polyisocyanurate is in each case produced by the block foaming process and where the reactive mixture provided in step I-2) comprises as the first component (K1) at least one polyisocyanate and as the second component (K2) at least one compound having isocyanate-reactive groups and as a further component at least one blowing agent.
